(19) United States
(12) Patent Application Publication
(10) Pub. No.: US 2008/0182000 A1
(43) Pub. Date: Jul. 31, 2008

(54) Apparatus and Method for Movement and Rotation of Dough Sheets to Produce a Bakery Products

(75) Inventors: Terry E. Groff, Wernersville, PA (US); Joseph S. Zaleski, Mohrsville, PA (US); Jeffrey L. Hardick, Bernville, PA (US); Vincent G. Pasquini, Hershey, PA (US); Mark E. Williamson, Cheshire (GB)

Correspondence Address: PANITCH SCHWARZE BELISARIO & NADEL LLP, ONE COMMERCE SQUARE, 2005 MARKET STREET, SUITE 2200, PHILADELPHIA, PA, 19103, US

(73) Assignee: Reading Bakery Systems, Robesonia, PA (US)

(21) Appl. No.: 12/061,328

(22) Filed: Apr. 2, 2008

Related U.S. Application Data
(62) Division of application No. 10/241,055, filed on Sep. 10, 2002.

(51) Int. Cl. A21D 6/00

(52) U.S. Cl. 426/502

(57) ABSTRACT

The present invention is a bakery product produced by compressing stacked sheets of dough into a laminate and baking the laminate. The bakery product includes a first sheet of dough and a second sheet of dough. The first sheet of dough has a first grain direction. The second sheet of dough has a second grain direction. The second sheet of dough is positioned in facing engagement on the first sheet of dough to form a laminate of dough, wherein the first and second grain directions are positioned generally not parallel with respect to each other. The present invention is also directed to the apparatus and method used for producing the above-described bakery product.

### CROSS-REFERENCE TO RELATED APPLICATIONS

This application is a divisional of U.S. application Ser. No. 10/241,055, filed Sep. 10, 2002, and the disclosure of which is incorporated herein by reference.

### BACKGROUND OF THE INVENTION

This invention relates to an apparatus and a method for picking up dough sheets, moving them to another location, selectively rotating them, and placing them down.

It is generally known that one can influence the texture of cracker, pastry, and other bakery products through a technique of lamination in which layers of rolled out dough are stacked one upon the other and then compressed and rolled to a single dough sheet from which the final dough product is formed. During baking, steam and released leavening gases are captured between the various layers causing the product to rise by breaking free along joint lines between the layers. A final product manufactured using the technique of lamination obtains a softer, more pleasant texture than if the lamination process was not used in the production technique.

An early machine used to complete the lamination process in automated bakery production was the “folding laminator” or “folding lapper”. The folding laminator fed the dough to the production line at right angles and, through the use of a reciprocating conveyor, folded the dough back and forth on the transverse conveyor. Although the process using the folding laminator was simple and had the desired effect on texture, the folding laminator caused other significant problems in high-speed manufacture of some bakery products such as crackers. The most significant problem of the folding laminator was the production of a final dough sheet with varying densities. The design of the folding laminator made it impossible to cover the sheet below with a continuous sheet of dough. In particular, the edges of the sheet tended to be denser than a central area of the sheet due to the folds of dough along the edges. Other inconsistencies in density were caused by speed of the process and settings of the laminator and resulted in the possibility of uncovered areas of the sheet and/or accidental multiple folds. Also, folding of the sheet on a transverse conveyor created stress in the dough sheet, resulting in shrinkage of the product in one dimension or the other. This dimensional change, coupled with the height variations caused by inconsistent densities, caused packaging problems for high speed packaging systems which were designed to package crackers of specific dimensions.

A strategy used to reduce the dimensional stress and volume variation was limiting the amount of old dough that is returned to the initial sheeting roll set. Old dough reenters the process primarily from dough that was cut off from the edges of the dough sheet in order to attain straight, uniform edges. Old dough is thought to exhibit different baking characteristics than fresh dough. For this reason, it is desirable to keep the amount of edge scrap to a minimum.

In order to reduce inaccurate lamination and lessen the amount of edge scrap, another machine was used for the lamination process called the “cut sheet” laminator. The cut sheet laminator used a rotary knife to cut sheets into slabs. The cut sheet was then conveyed by a conveyor that runs at a right angle to the production line. The end of the conveyor reciprocated in such a way as to deposit the sheet onto the transverse page conveyor. Through the use of optical encoders and servo motor drives, the sheet could be deposited accurately, resulting in less edge scrap to be removed. Although the cut sheet laminator was an improvement on the folding laminator, cut sheet laminators tend to be very expensive and extremely complex machines. Because of the complexity of the cut sheet laminator, it was not only difficult and time-consuming to repair and maintain, but was also hard to clean. Moreover, the cut sheet laminator still imparted stress to the dough due to the acceleration and deceleration zones of the reciprocating conveyor, resulting in production of crackers that shrank differently from one side of the oven to the other. Such dimensional variation caused problems for high-speed packaging systems which were similar to those used with the folding laminator.

Some of the problems of the cut sheet laminator were remedied by a vacuum laminator. The vacuum laminator was simple, inexpensive, and easy to clean and maintain.

The vacuum laminator had a vacuum belt. A sheet of dough was cut and transferred to the vacuum belt with no acceleration or deceleration of the sheet. Because there was no stretching of the sheet during the transfer, there was no stress created. The top of the sheet adhered to the bottom of the vacuum belt in order to transfer the sheet to the page conveyor. The sheet was released from the vacuum belt by a curtain of air delivered by a series of “air knife” nozzles positioned proximate the dough sheet/vacuum belt interface, which acted to peel the sheet from the belt. The sheet then fell from the vacuum belt; the fall was cushioned by the air trapped beneath the sheet. Because the sheet simply fell from the vacuum belt, this process relieved the dough sheet of all stress. With the vacuum laminator, it was possible to deposit the dough with accuracy similar to that of the cut sheet laminator without the use of expensive servo motors and optical encoders, as were used in the cut sheet laminator.

Even with such gentle handling, a dough sheet will still shrink a little after it is cut and baked, with the shrinkage always being greater in one direction than the other. This shrinkage pattern is caused by the grain effect of the dough sheet. A “grain” is caused by deformation of the protein fibrils present in dough. When wheat flour is hydrolyzed with water and mixing energy is added, the protein in the flour is converted to wheat gluten. Wheat gluten creates a viscous membrane that traps steam and leavening derived gasses. The protein fibrils of the wheat gluten are elastic. When the dough is put under the stress of compression, the protein fibrils tend to move in a similar direction.

The vacuum laminator of the present invention seeks to remedy the grain effect problem of previous vacuum laminators. The present invention comprises a pick-and-place vacuum laminator that allows bakers to laminate the sheet by turning every second sheet ninety degrees, thus cross-graining the laminated sheet. The cross-grained sheet divides the imparted stress by dividing the stress into separate planes. For this reason, cross-grained sheets shrink less than sheets with all of the grain applied in a single direction. This improvement to lamination has the substantial commercial effect of proving product quality while improving packaging efficiency because of the improved uniformity of products produced by cross lamination. The cross laminating vacuum laminator also has the same benefits over previous technology as the earlier vacuum laminators had, including accurate lamination, reduced edge scrap, ease of cleaning and maintaining, and relatively low cost.

### BRIEF SUMMARY OF THE INVENTION

Briefly stated, in one aspect, the present invention is a bakery product produced by compressing stacked sheets of dough into a laminate and baking the laminate. The bakery product includes a first sheet of dough and a second sheet of dough. The first sheet of dough has a first grain direction. The second sheet of dough has a second grain direction. The second sheet of dough is positioned in facing engagement with the first sheet of dough to form a laminate of dough, wherein the first and second grain directions are not parallel with respect to each other.

In another aspect, the present invention is a bakery product produced by compressing stacked sheets of dough into a laminate and baking the laminate. The bakery product includes a plurality of sheets of dough. Each sheet has a predetermined grain direction. The plurality of sheets of dough is positioned in stacked, facing engagement with each other to form the laminate of dough such that the grain directions of adjacent sheets of dough are not parallel with respect to each other.

In another aspect, the present invention is a method of producing a bakery product to promote uniform and consistent expansion during baking of the bakery product. The method includes the following steps: a block of dough is rolled in a first direction, the rolling creating a block sheet of dough having a grain direction; at least a first sheet of dough and a second sheet of dough are cut from the block sheet of dough; the first sheet of dough is stacked into facing engagement with the second sheet of dough such that the grain direction of the first sheet is not parallel relative to the grain direction of the second sheet of dough; and the stacked first and second sheets of dough are compressed, the compression of the first and second sheets of dough producing a laminate comprised of the first and second sheets of dough.

In another aspect, the present invention is a machine for creating a bakery product sheet that is divided into a plurality of individual sheets. The bakery product machine includes a conveyor, a vacuum surface, a first actuator, a second actuator, and a third actuator. The conveyor has a conveying surface that transports the plurality of sheets in a first direction. The vacuum surface is movably secured adjacent and above the conveyor surface. The vacuum surface is capable of up/down, parallel, and rotational movement with respect to the first direction. The first actuator is configured to move the vacuum surface along and generally parallel to the conveying surface. The second actuator is configured to move the vacuum surface between a first position proximate the conveying surface and a second position above and spaced from the conveying surface. The third actuator is configured to rotate the vacuum surface about a vertical axis of rotation that extends generally perpendicularly with respect to the conveying surface. The conveying surface has a first sheet in facing engagement therewith. The second actuator causes the vacuum surface to move from the second position to the first position so as to be located proximate the conveying surface and the first sheet. The vacuum surface creates a vacuum force to lift the first sheet from the conveying surface. The second actuator moves the vacuum surface and first sheet to the second position. The first actuator moves the vacuum surface and first sheet from the second position to a third position generally above a predetermined drop-off location of the conveying surface. The third actuator rotates the vacuum surface. The second actuator lowers the vacuum surface and first sheet from the third position to a fourth position proximate to the predetermined drop-off location. The vacuum surface releases the first sheet by ceasing the vacuum force so as to place the first sheet at the predetermined drop-off location.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown. In the drawings:

FIG. 1 is a side elevational view of a bakery product machine in a first position in accordance with a preferred embodiment of the present invention;

FIG. 2 is a side elevational view of the bakery product machine of FIG. 1 in a second position;

FIG. 3 is a side elevational view of the bakery product machine of FIG. 1 in a third position;

FIG. 4 is a side elevational view of the bakery product machine of FIG. 1 in a fourth position;

FIG. 5 is a side elevational view of the bakery product machine of FIG. 1 after releasing a sheet of bakery product;

FIG. 6 is a perspective view of a section of a bakery product sheet in accordance with the present invention; and

FIG. 7 is a schematic block diagram of the process of making a bakery product in accordance with the present invention.

### DETAILED DESCRIPTION OF THE INVENTION

Certain terminology is used in the following description for convenience only and is not limiting. The words “right,” left,” “lower,” and “upper” designate directions in the drawings to which reference is made. The words “inwardly” and “outwardly” refer to directions toward and away from, respectively, the geometric center of the humidifier and designated parts thereof. The terminology includes the words above specifically mentioned, derivatives thereof and words of similar import. Additionally, the word “a,” as used in the specification, means “at least one.”

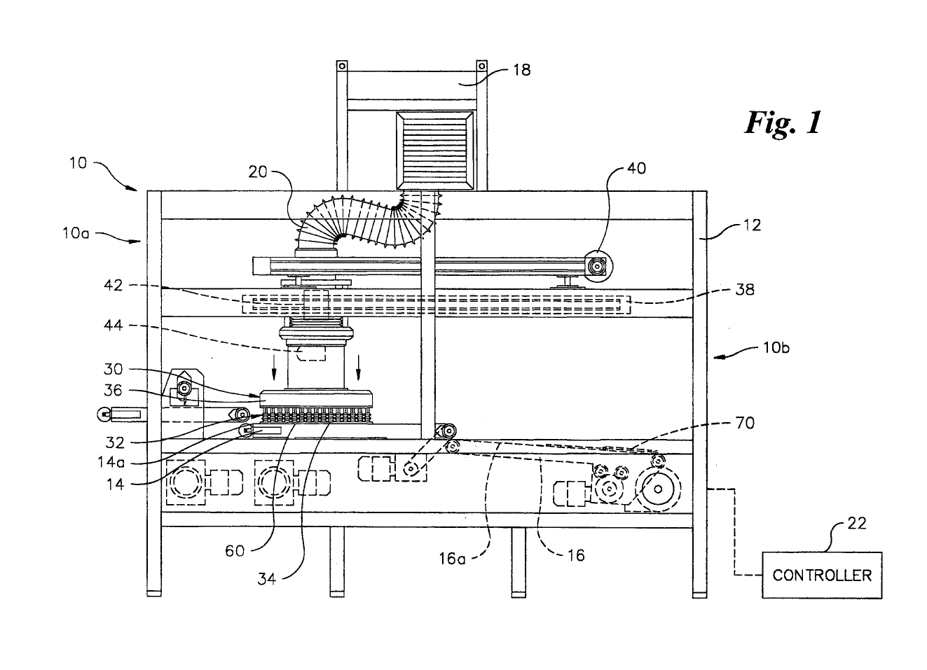

Referring to the drawings in detail, wherein like numerals indicate like elements throughout, there is shown in FIGS. 1-6 a preferred embodiment of a bakery product machine and bakery product in accordance with the present invention. The bakery product machine is indicated generally at 10. The bakery product machine 10 comprises a vacuum head 30 mounted on a vacuum head track 38, which is supported by a frame 12. The bakery product machine 10 has an input side 10a and an output side 10b. Individual dough sheets 60 enter the bakery product machine 10 through the input side 10a and ultimately leave the bakery product machine 10 through the output side 10b in the form of a bakery product sheet 70. A first conveyor 14 and a second conveyor 16 are also supported by the frame 12, generally below the vacuum head 30. The first conveyor 14 has a first conveying surface 14a rotating around the first conveyor 14 such that a top surface of the conveying surface of 14a travels in a direction defined by a generally horizontal line from the input side 10a toward the output side 10b. The second conveyor 16 is positioned proximate the output side 10b and has a second conveying surface 16a that rotates around the second conveyor 16 such that a top surface of the second conveying surface 16a travels in generally the same direction as the first conveyor 14 toward the output side 10b.

The vacuum head 30 includes a vacuum surface 32. The vacuum surface 32 is made up of a two-dimensional matrix of a plurality of individual vacuum cups 34 mounted to a vacuum head body 36. The vacuum surface 32 is secured adjacent to and above the first conveyor 14. The vacuum surface 32 is capable of up/down, parallel, and rotational movement with respect to the first direction. Preferably, the vacuum surface 32 is approximately two feet in width and approximately two feet in length, although it is within the spirit and scope of the present invention that the width and length of the vacuum surface 32 be any reasonable dimension to accommodate the size of the objects intended to be lifted. A vacuum surface of a suitable type is disclosed in U.S. Pat. No. 5,687,641, the disclosure of which is incorporated herein by reference. It is preferred that the vacuum cups 34 be mounted closely together so that the space between the vacuum cups 34 is kept to a minimum, thereby decreasing the possibility of unevenly stressing and tearing the sheet of dough. Preferably, the vacuum cups 34 have a diameter of about 1.37 inches and are made of a soft polymeric material. Vacuum cups 34 of this type are generally known to those of ordinary skill in the art. Although the aforementioned vacuum cups 34 are preferred, it is understood by those skilled in the art that other types of vacuum cups 34 could be used, and the above-described vacuum cups 34 are not limiting. It is further understood that although vacuum cups 34 are preferred, any suitable media pick-up media can be used, such as cloth or filter material.

A first actuator 40 is configured to move the vacuum surface 32 along and generally parallel to the first conveying surface 14a. The first actuator 40 is mounted to the frame 12 above the vacuum head track 38 and preferably includes a motor (not shown) that drives a belt or chain drive assembly attached to the vacuum head 30 to move the vacuum head 30 back and forth along the vacuum head track 38. Although, the above-described first actuator 40 is preferred, it is within the spirit and scope of the present invention that the first actuator 40 can also be a piston assembly, a rack and pinion assembly, or any other suitable drive assembly.

A second actuator 42 is configured to move the vacuum surface 32 upwardly and downwardly between a first position proximate the first conveying surface 14a and a second position above and spaced apart from the first conveying surface 14a. The second actuator 42 is positioned within the vacuum head 30 and preferably is comprised of at least one piston-like linear actuator (not shown) oriented in a direction generally perpendicular with respect to the first conveying surface 14a. The second actuator 42 causes the vacuum head 30 to lower and/or raise, thereby causing the distance between the vacuum head track 38 and the vacuum surface 32 to lengthen and/or shorten, respectively. Although the above described second actuator 42 is preferred, it is within the spirit and scope of the present invention that the second actuator 42 be another type of linear actuating device such as, but not limited to, a chain drive assembly, a rack and pinion assembly, or some other suitable device.

A third actuator 44 is configured to rotate the vacuum surface 32 about a vertical access of rotation that extends through the center of the vacuum surface 32 generally perpendicularly with respect to the first conveying surface 14a. The third actuator 44 causes the vacuum surface 32 to rotate in relation to the rest of the vacuum head 30. The third actuator 44 is preferably located within the vacuum head 30 and is comprised of a standard rotational actuator, specifically a ninety-degree rotary actuator. Although the above described third actuator 44 is preferred, it is within the spirit and scope of the present invention that the third actuator 44 be another type of rotational device such as, but not limited to, a stepper motor, a standard rotary motor, or some other suitable device.

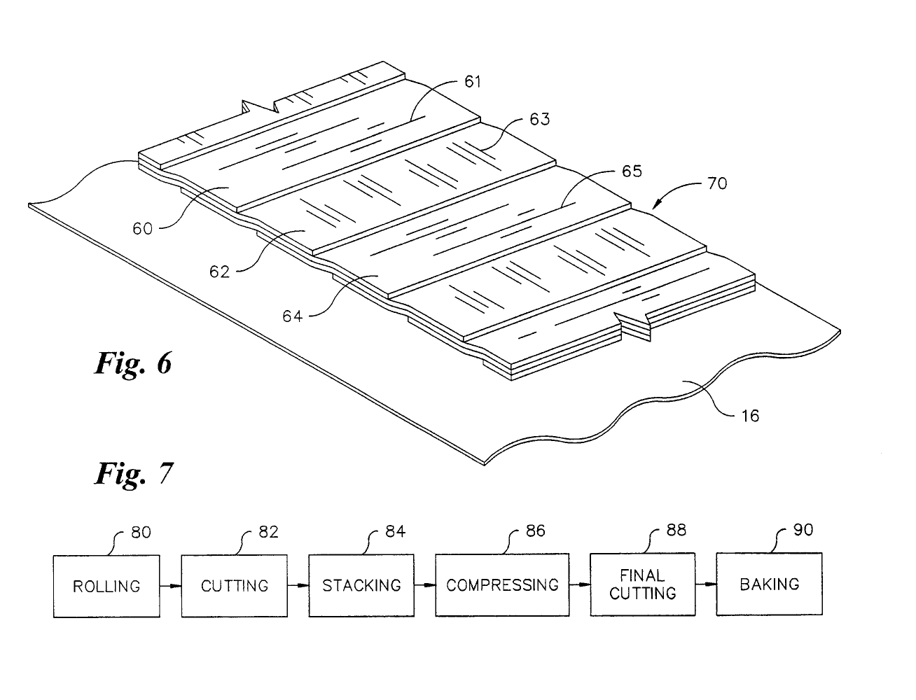

In operation, the bakery product machine 10 creates a bakery product sheet 70 from a plurality of overlapped individual sheets 60 (FIG. 6). Referring to FIG. 1, the individual sheets 60 enter the bakery product machine 10 through the input side 10a by traveling along the first conveyor 14. A first sheet 60 is in facing engagement with the first conveying surface 14a. The second actuator 42 causes the vacuum surface 32 to move from the second position to the first position so as to be located proximate the first conveying surface 14a and the first sheet 60, as shown in FIG. 1. The vacuum surface 32 then creates a vacuum force to lift the first sheet 60 from the first conveying surface 14a. The vacuum force is created by a vacuum pump (not shown) located within a vacuum housing 18 mounted to the top of the frame 12. The vacuum pump is connected to the vacuum head 30 by a flexible vacuum hose 20. A valve (not shown) within the vacuum pump can be selectively opened or closed to create or cease the vacuum force. It is preferable that the first actuator 40 accelerates the vacuum surface 32 to approximately the same speed as and in the same direction of the first conveying surface 14a when picking up the first sheet 60 to lessen the stresses imparted to the dough and decrease the possibility of tearing the first sheet 60 of dough.

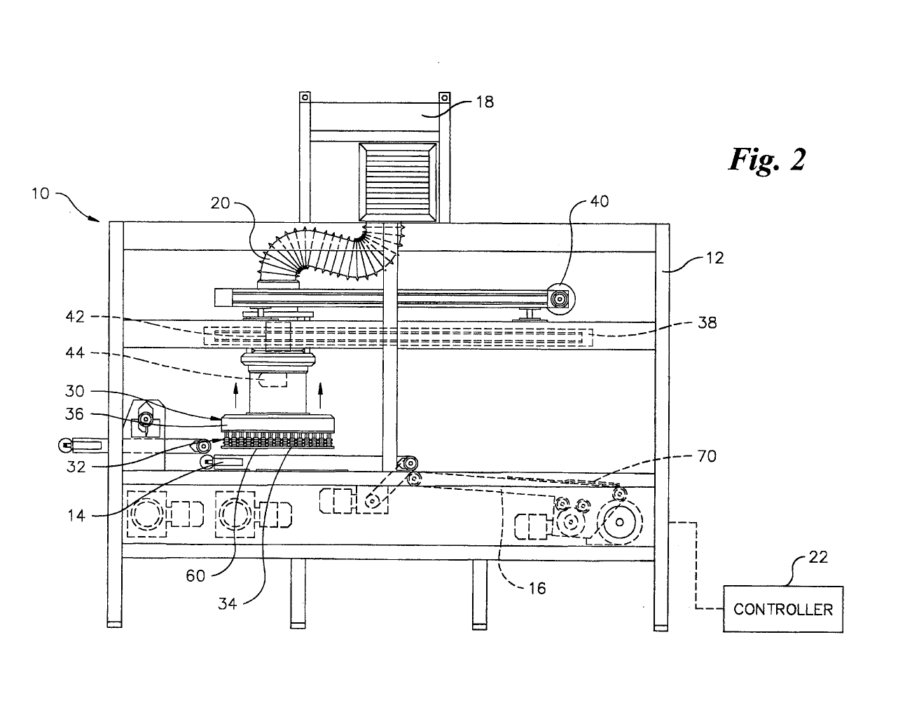

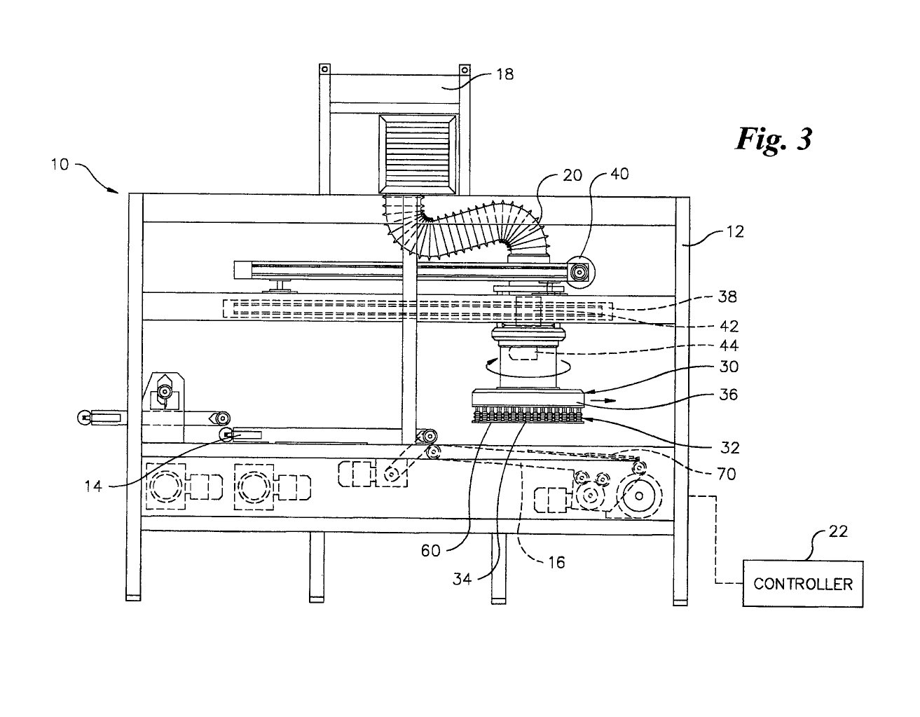

Referring to FIG. 2, the second actuator 42 moves the vacuum surface 32 and the first sheet 60 to the second position, thereby lifting the first sheet 60 off of the conveyor surface 14a. Referring to FIG. 3, the first actuator 40 then moves the vacuum surface 32 and the first sheet 60 from the second position to a third position generally above a predetermined drop-off location of the second conveyor surface 16a. The third actuator 44 also selectively rotates the vacuum surface 32, thereby rotating the first sheet 60. Preferably, every other sheet is rotated ninety degrees, thereby causing successive sheets to be oriented ninety degrees apart from each other. In this way, the grain directions of adjacent sheets are offset by ninety degrees. Although rotation of ninety degrees is preferred, it is within the spirit and scope of the present invention that the sheets be selectively rotated by any desired amount.

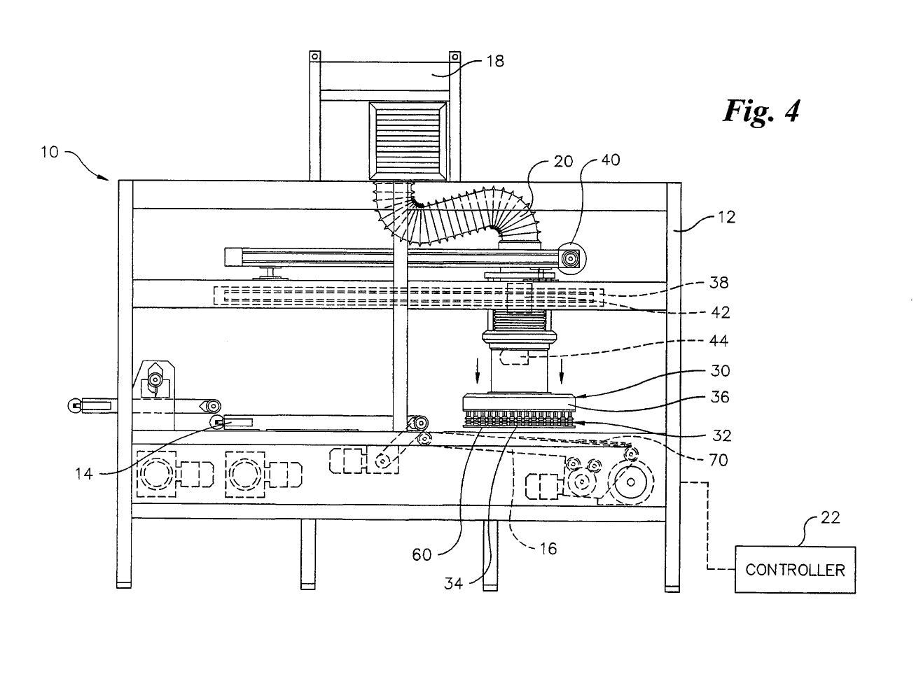

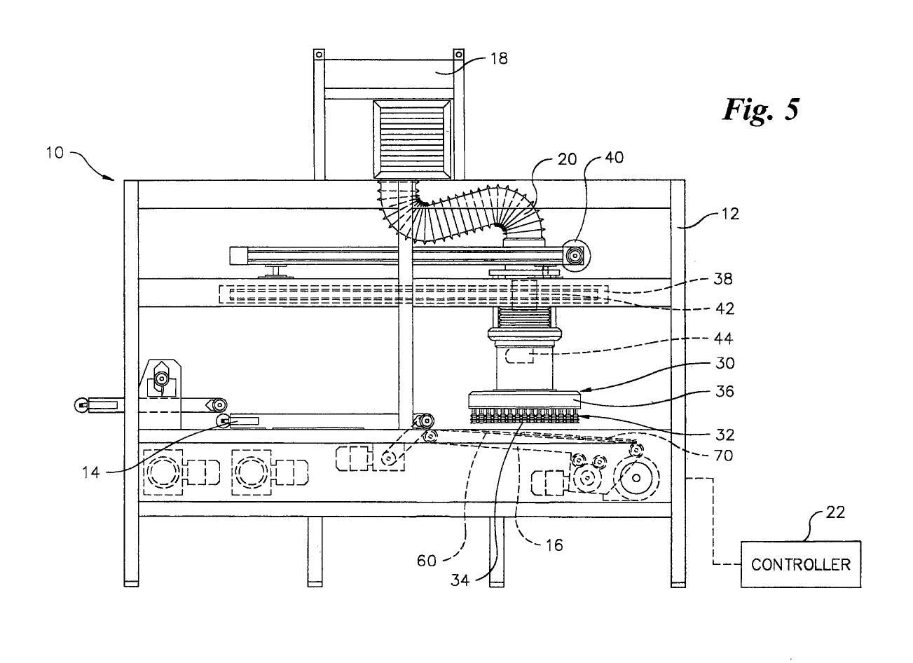

Referring now to FIG. 4, the second actuator 42 then lowers the vacuum surface 32 and the first sheet 60 from the third position to a fourth position proximate to the predetermined drop-off location of the second conveying surface 16a. Referring to FIG. 5, the vacuum surface 32 then releases the first sheet 60 by ceasing the vacuum force so as to place the first sheet 60 at the predetermined drop-off location of the second conveying surface 16a. It is preferable that the first actuator 40 maintains the vacuum surface 32 at approximately the same speed as and in the same direction of the second conveying surface 14a when dropping off the first sheet 60 to lessen the stresses imparted to the dough and decrease the possibility of tearing or folding the first sheet 60 of dough.

The bakery product machine 10 then repeats the above-described movements with a second sheet 62 of dough. The second sheet 62 is rotated so that a second grain direction 63 of the second sheet 62 is preferably ninety degrees relative to the first grain direction 61 of the first sheet 60. The second sheet 62 is then deposited at the drop-off location such that the second sheet 62 partially overlaps the first sheet 60. This process can then be repeated with a third sheet 64 of dough having a third grain direction 65. The bakery product machine 10 is configured such that the amount of overlap between the first and second sheets 60, 62 is the same as the amount of overlap between any two adjacent sheets of dough. The amount of overlap between two adjacent sheets of dough can be set by a user and effectuated by slowing or speeding up the speed of either the second conveyor 16 or the movements of the vacuum surface 32. Speeding up the second conveyor 16 or slowing the movements of the vacuum surface 32 have the effect of decreasing the amount of overlap while slowing the second conveyor 16 or speeding up the movements of the vacuum surface 32 have the effect of increasing the amount of overlap.

In this way, sheets of dough 60, 62, 64 are placed onto the second conveyor 16 in a layered manner to create a bakery product sheet 70, as shown in FIG. 6. The bakery product machine 10 of the present invention is capable of accurately placing the sheets 60, 62, 64 onto the second conveyor 16 in line and at regularly spaced intervals. The accurate placement of sheets 60, 62, 64 lessens the amount of edge scrap due to improper lining-up of the edges of the sheets 60, 62, 64 and also promotes the uniform thickness of the bakery product sheet 70. The sheets 60, 62, 64 each have a respective grain direction 61, 63, 65, denoted by a series of lines on the top of the sheets 60, 62, 64. Dough tends to expand more in a direction perpendicular to the grain direction than in a direction parallel with the grain direction. By alternating rotation of the sheets 60, 62, 64, expansion of the final product cut from the sheets 60, 62, 64 during baking is not greater in one direction than another.

The bakery product machine 10 further comprises a controller 22. The controller 22 is preferably a programmable logic controller (PLC) that can be programmed by the user to achieve the desired overlap between adjacent sheets 60, 62, 64 of dough, the desired rotation of sheets 60, 62, 64, the desired pick-up and drop-off locations, and the desired vacuum force. The controller 22 actuates the first actuator 40 to move the vacuum surface 32 along and generally parallel to the first conveying surface 14a. The controller 22 also actuates the second actuator 42 to move the vacuum surface 32 toward and away from the first conveying surface 14a. The controller 22 actuates the third actuator 44 to rotate the vacuum surface 32 relative to the first conveying surface 14a. The controller 22 further actuates the valve within the vacuum pump to create and cease the vacuum force. Sensors (not shown) can be used at the first and second conveyors 14, 16 to sense the placement of the sheets 60, 62, 64 of dough on the first conveyor surface 14a to ensure full engagement of the vacuum surface 32 with the sheets 60, 62, 64 of dough at the pick-up location and to ensure proper placement of the sheets 60, 62, 64 at the drop-off location such that the edges of the sheets 60, 62, 64 are properly aligned and the amount of overlap between adjacent sheets 60, 62, 64 of dough is uniform. The sensors can be infra-red sensors, visual sensors, or any other suitable sensing means.

The programmable controller 22 gives the user complete control to quickly and easily customize the lamination technique to make it appropriate for any type of dough or product. The bakery product machine 10 can be programmed to rotate all sheets 60, 62, 64 of dough, every other sheet of dough, no sheets of dough, or any combination thereof. More particularly, the bakery product machine 10 can be programmed to rotate all sheets 60, 62, 64 such that the grain direction of each sheet is parallel to the direction of travel of the second conveyor 16, such that the grain direction of each sheet is perpendicular to the direction of travel of the second conveyor 16, or such that the grain directions are alternated in a preset pattern or are randomly arranged to create differently layered products.

The first conveyor 14 is adjustable such that under normal operation, there is a gap between the first and the second conveyors 14, 16. This allows small scraps of dough, incomplete sheets of dough, and other scrap to fall off of the first conveyor 14, through the gap, and into an awaiting recycle bin below. However, if desired, the first conveyor 14 can be extended to close the gap and allow sheets 60, 62, 64 of dough to be transferred directly from the first conveyor 14 to the second conveyor 16 without lamination.

In another aspect of the present invention, a method of producing a bakery product promotes uniform and consistent expansion during baking and includes the following steps. Referring to FIG. 7, first, a block of dough is rolled in a first direction during a rolling step 80. The rolling creates a block sheet of dough having a single block sheet grain direction. At least a first sheet 60 and a second sheet 62 of dough are cut from the block sheet of dough during an initial cutting step 82. During a stacking step 84, the first sheet 60 is stacked into facing engagement with the second sheet 62 such that a first grain direction 61 of the first sheet 60 is positioned generally not parallel and preferably orthogonal relative to a second grain direction 63 of the second sheet 62. Preferably, the first sheet 60 and the second sheet 62 are rotated 90 degrees from another, although it is in the spirit and scope of the present invention that the first and second sheets 60, 62 be rotated at any desired angle relative to each other. The stacking of the first and second sheets 60, 62 creates the bakery product sheet 70 (FIG. 6). The stacked first and second sheets 60, 62 are then compressed in a compressing step 86 to produce a laminate 72 comprised of the first and second sheets 60, 62.

The above-described process can also include a third sheet 64 of dough with a third grain direction 65. The process would then include in the initial cutting step 82 the cutting of the third sheet 62 from the block sheet of dough. The third sheet 64 would then be stacked in facing engagement with the second sheet 62 in the stacking step 84 such that the third grain direction 65 of the third sheet 64 is positioned generally parallel relative to the first grain direction 61. The first, second, and third sheets 60, 62, 64 would then be compressed in the compressing step 86 to produce the laminate 72 comprised of the first, second, and third sheets 60, 62, 64. Although the process is described having three sheets 60, 62, 64, it is within the spirit and scope of the present invention that the process has any number of sheets. The laminate 72 can then be cut into a predetermined shape in a final cutting step 88, which can be any shape including, but not limited to, a square, a rectangle, and a circle. The predetermined shape can then be baked in a baking step 90 to produce a final bakery product.

Preferably, the first and second sheets 60, 62 are conveyed on the first conveyor 14 after cutting the initial cutting step 82 and prior to the stacking step 84. The first sheet 60 is positioned at a first position on the first conveyor 14 that is actually spaced in the direction of travel of the first conveyer 14 with respect to the second sheet 62. The first sheet 60 is lifted from the first conveyor 14 and rotated prior to being stacked into facing engagement with the second sheet 62 at the drop-off location.

In another aspect, referring to FIGS. 6 and 7, the present invention is the bakery product produced by compressing stacked sheets of dough into the laminate 72 during the compressing step 86, and then baking the laminate 72. The bakery product comprises a first sheet 60 of dough having a first grain direction 61. The bakery product further comprises a second sheet of dough 62 having a second grain direction 63. The second sheet 62 is positioned partially on top of and in facing engagement with the first sheet 60 and then compressed to form the laminate 72 of dough. The first and second grain direction 61, 63 are positioned generally not parallel with respect to each other. The bakery product can further comprise a third sheet 64 of dough having a third grain direction 65. The third sheet 64 is positioned in facing engagement on the second sheet 62 such that the third grain direction 65 is positioned generally not parallel with respect to the second grain direction 63. Although the above-described bakery product comprises three sheets 60, 62, 64, it is within the spirit and scope of the present invention that the bakery product 100 be comprised of a plurality of sheets of dough each having a predetermined grain direction. The plurality of sheets of dough is positioned in stacked facing engagement with each other to form the laminate 72 of dough such that the predetermined grain directions of adjacent sheets of dough are generally not parallel to each other.

The present invention is not limited to arranging the grain directions in an alternating fashion. That is, because the bakery product machine 10 can easily programmed to arranged the grain directions in any direction, it is capable of making bakery products wherein the grain directions are parallel to each other, perpendicular to each other or any combination thereof. Rendering the bakery product machine 10 highly versatile. Furthermore, the present invention is not limited to picking up and placing sheets of dough between two conveyors. For instance, the vacuum surface 32 could be controlled to pick up sheets of dough from two separate conveyors and then combining them on a single conveyor. Such an approach would be particularly useful if the sheets of dough on the two conveyors are of different flavors, such as vanilla and chocolate. In this manner, the final dough product would have alternating chocolate and vanilla layers of dough, creating a multi-flavored product.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

I/we claim:

1. A method of producing a bakery product to promote uniform and consistent expansion during baking comprising the steps of:
rolling a block of dough in a first direction, the rolling creating a block sheet of dough having a grain direction;
cutting at least a first sheet of dough and a second sheet of dough from the block sheet of dough;
stacking the first sheet of dough into facing engagement with the second sheet of dough such that the grain direction of the first sheet of dough is not parallel relative to the grain direction of the second sheet of dough; and
compressing the stacked first and second sheets of dough, thereby producing a laminate comprised of the first and second sheets of dough.

2. The method of claim 1, wherein the cutting step further comprises cutting a third sheet of dough from the block sheet of dough; the stacking step further comprises stacking the third sheet of dough in facing engagement with the second sheet of dough such that the grain direction of the third sheet of dough is parallel relative to the grain direction of the first sheet of dough; and the compressing step further comprises compressing the first, second, and third sheets of dough, thereby producing a laminate comprised of the first, second, and third sheets of dough.

3. The method of claim 1, further comprising the step of:
cutting the laminate into a predetermined shape; and
baking the predetermined shape to produce a final bakery product.

4. The method of claim 1, wherein the cutting step further comprises the steps of:
conveying on a conveyor the first sheet of dough positioned at a first position on the conveyor that is axially spaced in the direction of travel of the conveyor with respect to the second sheet of dough, and
lifting the first sheet of dough from the conveyor and rotating the first sheet of dough.

5. A method of producing one of a plurality of bakery products comprising the steps of:
rolling a block of dough in a first direction, the rolling creating a block sheet of dough having a grain direction;
cutting at least a first sheet of dough and a second sheet of dough from the block sheet of dough;
arranging the grain direction of the second sheet of dough with respect to the first sheet of dough such that the grain direction of the second sheet of dough is either not parallel relative to the grain direction of the first sheet of dough, parallel relative to the grain direction of the first sheet of dough, or perpendicular relative to the grain direction of the first sheet of dough;
stacking the first sheet of dough into facing engagement with the second sheet of dough after the arranging step; and
compressing the stacked first and second sheets of dough, thereby producing a laminate comprised of the first and second sheets of dough.

6. The method of claim 5, further comprising the steps of:
cutting a third sheet of dough from the block sheet of dough;
arranging the grain direction of the third sheet of dough with respect to the first sheet of dough such that the grain direction of the second sheet of dough is either not parallel relative to the grain direction of the first sheet of dough, parallel relative to the grain direction of the first sheet of dough, or perpendicular relative to the grain direction of the first sheet of dough;
stacking the third sheet of dough in facing engagement with the second sheet of dough; and
compressing the first, second, and third sheets of dough, thereby producing a laminate comprised of the first, second, and third sheets of dough.
